(19) United States
(12) Patent Application Publication
(10) Pub. No.: US 2019/0126563 A1
(43) Pub. Date: May 2, 2019

(54) METHOD FOR PRODUCING A MOULDED PART ASSEMBLY AND CORRESPONDING PRODUCTION DEVICE

(71) Applicant: AFT AUTOMOTIVE GMBH, Greven-Reckenfeld (DE)

(72) Inventors: Daniel HEMKER, Osnabrück (DE); Patrick HUES, Münster (DE); Andreas MÄRTEN, Nörten-Hardenberg (DE); Dirk KRAMER, Havixbeck (DE)

(21) Appl. No.: 16/083,672

(22) PCT Filed: Mar. 8, 2017
(86) PCT No.: PCT/EP2017/055483

§ 371 Date: Sep. 10, 2018

(30) Foreign Application Priority Data
Mar. 11, 2016 (DE) 10 2016 204 066.9

(51) Int. Cl. B29C 65/16; B29C 65/00

(52) U.S. Cl. CPC B29C 65/1635; B29C 65/168; B29C 66/1122; B29C 66/114; B29C 66/116; B29C 66/1222; B29C 66/73116; B29C 66/1226; B29C 66/65; B29C 66/723; B29C 66/83221; B29C 66/92615; B29C 66/92921; B29C 66/1224

(57) ABSTRACT

The application relates to a method for producing a moulded part assembly from a first plastic moulded part and a second plastic moulded part by means of laser welding, wherein the first plastic moulded part consists at least partially of a first material and the second plastic moulded part consists at least partially of a second material that can be welded to the first material, wherein a welding region of the second plastic moulded part is arranged in a stepped receiving means of the first plastic moulded part, or vice versa. According to the invention, during the laser welding, the first plastic moulded part and the second plastic moulded part are to be shifted onto one another in a shifting direction. The invention also relates to a production device for producing a moulded part assembly.

The invention relates to a method for producing a molded part assembly from a first plastic molded part and from a second plastic molded part by laser welding, wherein the first plastic molded part consists at least partially of a first material and the second plastic molded part consists at least partially of a second material which can be welded to the first material, wherein a welding region of the second plastic molded part is arranged in a stepped receiving means of the first plastic molded part or vice versa. Furthermore, the invention relates to a production device for producing a molded part assembly.

The method serves to produce the molded part assembly. To this end, at first at least the first plastic molded part and the second plastic molded part are made available. Subsequently, the first plastic molded part and the second plastic molded part are connected to one another for producing or forming the molded part assembly by laser welding. In order to make the laser welding possible, the first plastic molded part consists at least partially of the first material and the second plastic molded part consists at least partially of the second material. A plastic is used as the first material and as the second material.

For example, the first material is laser-transparent, in contrast to which the second material is laser-absorbent. This means that the first material has a higher degree of transmission for the wavelength or the wavelength range of the laser beam or of the laser light used for the laser welding than the second material does, or vice versa the second material has a greater opacity for the wavelength or the wavelength range than the first material. However, there can be another embodiment in which the second material is laser-transparent and the first material is laser-absorbent. The first material can be welded to the second material and vice versa. This means that the two materials enter a firmly bonded connection to one another and/or are brought into such a connection by the laser welding.

The laser beam is aligned, for example, in such a manner for the laser welding that it first passes the first plastic molded material and passes at least partially through the first plastic molded part to the second plastic molded part. Therefore, the laser beam is at least partially aligned onto the first plastic molded part. The laser beam or part of the laser beam reaching the second plastic molded part preferably passes completely through the first plastic molded part. This is made possible—in as far as the first material is laser-transparent and the second material laser-absorbent—by the higher degree of transmission of the first material in comparison to the second material.

During the laser welding, energy is charged into the second plastic molded part of the laser beam in the framework of the previously explained example and is converted there in the laser-absorbing, second material into heat. Accordingly, the second plastic molded part heats up in sections under the influence of the laser beam. During the laser welding the second plastic molded part or the second material is melted in sections by the laser beam on account of the heat produced by it, as a result of which a firmly bonded connection of the second plastic molded part to the first plastic molded part results.

In addition or alternatively, the heat accumulating in the second plastic molded part can be transmitted by thermal transmission from the second plastic molded part onto the first plastic molded part so that its temperature also rises. This can have the result that even the first plastic molded part or the first material is melted in sections and unites with the second plastic molded part or the second material, in particular with the molten, second plastic molded part or the molten second material.

For example, the first plastic molded part and the second plastic molded part are present as a fluid line element. The first plastic molded part is preferably a fluid coupling, in particular a rapid fluid coupling, whereas the second plastic molded part is a fluid line or a fluid tube. Such assemblies of fluid coupling and fluid line are frequently used in the motor vehicle area, for example, for producing a fuel connection.

The first plastic molded part and the second plastic molded part are especially preferably produced with different production processes. For example, the first plastic molded part is formed by injection molding and the second plastic molded part by extruding. The first plastic molded part can be present to this extent as an injection-molding molded part and the second plastic molded part as an extrusion molded part.

For example, the publication WO 2008/068328 A2 is known from the prior art. It describes a method for laser welding at least two structural components consisting of plastic, in particular a tube and a carrier plate, wherein the first structural component has a relatively high permeability at least in sections for the laser beam used in laser welding, and wherein the second structural component has a relatively low permeability at least in sections for the laser beam used in laser welding. A compact structural form should be achieved for the structural components in that the laser beam passes during the laser welding by refraction and/or reflection to the particular welding site. Such a procedure must in any case be monitored with a very high expense. Appropriate devices are only technically difficult and cost-intensive to convert.

Furthermore, for example, the publication EP 1 048 439 A2 is known from the prior art. It describes a method and a device for welding, wherein for connecting two surfaces of thermoplastic plastic in the radiographic welding method a covered surface is multiply scanned through an uncovering surface with a laser beam in a working cycle and gradually heated as a result. This preheating is repeated until the melting temperature has been achieved. As a consequence, a melt is simultaneously produced over the entire seam length in the area of the covered surface which moistens the uncovering surface and is also transformed into a melt by thermal conduction. At the beginning of the softening of the material the surfaces are moved against one another until a stop. As a result, the two surfaces are welded in principle in such a manner as if they were simultaneously plasticized over the entire seam length.

A device for laser welding a connection between a first joint surface of a structural component and a second joint surface of another structural component is known from the publication DE 200 23 490 U1.

Furthermore, the publications EP 1 710 007 A1, EP 2 505 338 A1, EP 2 500 161 A2, JP 2011-255683 A1, JP 2007-253416 A, JP 2008-221684 A, JP 2015-66750 A, and JP 2009-72987 A are known from the prior art.

Therefore, the invention has the problem of suggesting a method for producing a molded part assembly which has advantages compared to known methods, and in particular makes possible a monitoring of the laser welding and the recognition of waste in a manner which is simple and has a reliable process.

This is achieved in accordance with the invention with the method with the features of claim 1. This provides that the first plastic molded part and the second plastic molded part are shifted against one another during the laser welding in the direction of shifting. Therefore, it is provided on the whole that at first the second plastic molded part, especially its welding region, is arranged in the stepped receiving means of the first plastic molded part. Subsequently, the first plastic molded part and the second plastic molded part are shifted onto one another during the laser welding. The shifting direction used is preferably in the direction of a longitudinal central axis of the first plastic molded part and/or of the second plastic molded part. The longitudinal central axis of the first plastic molded part and/or the longitudinal axis of the second plastic molded part correspond, for example to the longitudinal central axis of a recess present in the particular plastic molded part, therefore, in the case of the first plastic molded part in particular to the receiving means.

At least the first plastic molded part has a special construction or shaping. Thus, it comprises the stepped receiving means which is designed to receive at least in areas the second plastic molded part or the welding region. Inversely, of course, the second plastic molded part can comprise the stepped receiving means, which is then provided for receiving at least in areas the first plastic molded part and/or the welding region of the first plastic molded part. The term stepped receiving means denotes a recess of the particular plastic molded part which has different cross sections in the direction of a longitudinal central axis of the plastic molded part, therefore cross sections spaced in the axial direction from each other with different dimensions or cross-sectional areas. The welding region is an area or partial area of the particular other plastic molded part, that is, of the first plastic molded part or of the second plastic molded part which is positively connected by the laser welding to the plastic molded part comprising the receiving means.

For the sake of simplicity, only one embodiment will be discussed in the following in which the first plastic molded part comprises the receiving means in which the second plastic molded part is arranged or can be arranged. However, the particular embodiments can of course always be transferred to an embodiment for which this is the inverse, that is, that the second plastic molded part comprises the receiving means in which the first plastic molded part can be arranged.

A step is formed in the receiving means for the positive connection by laser welding by which step the dimensions and/or the cross-sectional surface is changed. This step is preferably a contact element or an end stop for the second plastic molded part. To this extent a stop surface for the second plastic molded part is present on the step. It is preferably provided that the second plastic molded part is introduced into the stepped receiving means until it rests on the step. The laser welding is subsequently carried out.

During the laser welding the second plastic molded part and the first plastic molded part, in particular its step, are pressed against one another. Based on the first material and/or second material melted by the laser welding, the two plastic molded parts can be shifted onto one another, which is brought about by the impressing of an appropriate shifting force on the first plastic molded part and/or on the second plastic molded part.

The receiving means is preferably at least in sections and in particular completely cylindrical, especially circularly cylindrical. However, even other shapes of the receiving means can result as a function of an alignment of the step. In other words, it can be provided that the receiving means is, aside from the step, cylindrical, especially circularly cylindrical and especially preferably completely cylindrical. The receiving means extends, for example—at least viewed in the axial direction—from the step to a mouth opening of the receiving means which opening is opposite the receiving means.

In order to carry out the laser welding the laser beam is generated, which melts the first plastic molded part and/or the second plastic molded part in areas. The laser beam is preferably directed radially inward or outward. In the first instance an outer welding from—in a radial direction—outward and in the latter instance an inner welding from—in a radial direction—inward is performed. It is to be understood under the alignment of the laser beam in a radial direction that a radial component of its alignment or of its alignment vector is different from zero, or that the laser beam runs exclusively in a radial direction, and therefore the radial component is the single component of the alignment of the laser which is different from zero.

The laser beam can be already generated before the second plastic molded part is arranged in the receiving means if, therefore, the second plastic molded part is present outside of the receiving means. As an alternative, it can be provided that the laser beam is already generated during the introduction of the second plastic molded part into the receiving means, therefore, before the second plastic molded part rests on the step. However, it is especially preferable that at first the second plastic molded part is introduced as far as possible into the receiving means, in particular, therefore, until it rests on the step of the first plastic molded part. Only subsequently is the laser beam generated for carrying out the laser welding and during the presence of the laser beam the two plastic molded parts are shifted onto one another.

The shifting onto one another preferably takes place by the exerting of an appropriate shifting force onto the first plastic molded part and/or onto the second plastic molded part. It can be provided that the shifting force is applied already before the generation of the laser beam onto the first plastic molded part and/or onto the second plastic molded part. It can be additionally or alternatively provided that the shifting force is applied on to the first plastic molded part and/or onto the second plastic molded part after a deactivation of the laser beam in the form of a holding force at least for a certain holding time, in particular precisely for the certain holding time.

In order to shift the plastic molded parts onto one another and/or to apply the shifting force, one of the plastic molded parts can be held in place and the other one loaded with the shifting force and actually shifted. For this, it can be provided that for shifting the first plastic molded part and the second plastic molded part onto one another, only the first plastic molded part, only the second plastic molded part or both plastic molded parts can be shifted.

It is provided in the framework of another embodiment of the invention that a first welding surface of the first plastic molded part and which lies at least with a partial surface in a first rotational surface and faces the second plastic molded part is formed in the receiving means, and a front-side, second welding surface located in a second rotational surface and facing the first plastic molded part is formed on the second plastic molded part, wherein the first welding surface and the second welding surface lie on one another or are supported by an inserted part during the laser welding. The first welding surface, especially the partial surface, can form an end stop for the second plastic molded part. Each of the plastic molded parts comprises such a welding surface. The second welding surface forms at least in areas the welding region of the second plastic form part. During the laser welding, the two welding surfaces, that is, the first welding surface and the second welding surface, preferably lie on one another. In particular, they are pressed against one another by the shifting force. Alternatively, the insertion part can be present between the welding surfaces.

For example, the first welding surface of the first plastic molded part is formed at least in areas from the step of the receiving means. The first welding surface is located at least in areas in the first rotational surface, namely, at least with this partial surface. However, the first rotational surface can lie completely in one plane, respectively corresponding to such a plane. The rotational surface is generated preferably by the rotation of a line, in particular a straight line, about the longitudinal central axis of the first plastic molded part. To this extent, it is present as a linear rotational surface, in particular as a plane linear rotational surface. The line or its imaginary extension stands, for example, vertically on the longitudinal central axis or is bent relative to the latter. In the latter case a straight line including the line intersects—viewed in the longitudinal section—the longitudinal central axis at an angle different from 90°. The first welding surface or its partial surface is, for example, annular, preferably in the shape of a circular ring. It can also be present as a sectional surface of a cone envelope.

The second welding surface is associated with the second plastic molded part and lies on it on the front side. The second welding surface lies in the second rotational surface, in particular completely. That which was said for the first rotational surface basically applies to the second rotational surface. It can lie to this extent completely in one plane or correspond to such a plane. It is preferably created by the rotation of a line, for example, of a straight line, about the longitudinal central axis of the second plastic molded part. It, respectively its imaginary extension, can stand vertically on the longitudinal central axis or be bent relative to the latter, wherein—viewed in the longitudinal section—a straight line including the line in itself intersects the longitudinal central axis at an angle which differs from 90°. The second welding surface can also be annular, in particular have a circular ring shape, for example if the second plastic molded part is present as a fluid line or is designed as a sectional surface of a cone envelope.

The line defining the first rotational surface and/or the second rotational surface can consist of a single line part which is preferably straight. However, it can alternatively consist of several line parts adjacent to each other, wherein at least one of the line parts is straight. For example, several or all of the line parts are straight. It can be provided that two straight line parts from another line part are connected to one another which is not straight, for example which runs in a curve, in particular with a constant curvature. However, the other line part can also be straight and is especially preferably bent here opposite the particular adjacent line parts, and therefore encloses an angle with them which is greater than 0° and less than 180°. Furthermore, the other line part is preferably shorter than at least one of the line parts adjacent to it or than both adjacent line parts. In a corresponding manner, the particular rotational surface has two partial services which are connected by a bevel.

The inserted part—if provided—is preferably melted, preferably completely, during the laser welding. It transfers, at least to the extent that it is not yet melted, the shifting force and/or the holding force between the plastic molded parts. It consists, for example, for the melting, of laser-absorbing material so that it is heated by the laser beam and is directly melted. In this case it can be provided that heat is transferred from the insertion part onto the first plastic molded part and/or onto the second plastic molded part so that at least one, in particular both of the plastic molded parts is/are also melted. The plastic molded parts can consist here selectively of laser-transparent or laser-absorbing material. However, it can also be heated and finally melted by the transfer of heat from the first plastic molded part and/or the second plastic molded part. In such an embodiment the insertion part can consist of a laser-transparent material but also of a laser-absorbing material.

Another embodiment of the invention provides that the first welding surface and the second welding surface are constructed in such a manner that the first rotational surface and the second rotational surface—viewed in the longitudinal section—are bent parallel to one another or against one another, and/or that the first rotational surface and/or the second rotational surface stand vertically on the shifting direction. It was already explained above that the first rotational surface defines at least partially the first welding surface and that the second rotational surface defines the second welding surface. The two welding surfaces should now be designed in such a manner that a certain arrangement of the two rotational surfaces to one another and/or to the shifting direction results. On the one hand, the two rotational surfaces can run parallel to one another in the longitudinal section. Here, they preferably stand vertically on the shifting direction or the longitudinal central axis.

However, it can also be provided that the two rotational surfaces are bent relative to one another. It is preferably provided here that at least the second rotational surface continues to stand vertically on the shifting direction so that the first rotational surface is obliquely arranged opposite the shifting direction, that is, it encloses an angle with it that is different from 90°. Of course, both rotational surfaces can also be obliquely arranged as regards the shifting direction. They are preferably angled against one another here so that they enclose different angles with the shifting direction. It can be especially preferably provided here that—viewed in the longitudinal section on the same side of the longitudinal central axis—the first rotational surface is angled in a first direction and the second rotational surface is angled in a second direction different from the first direction and opposite the shifting direction.

A preferred another embodiment of the invention provides that the first welding surface is formed with at least one other partial surface which is angled opposite the partial surface. The first welding surface is therefore composed not only of the partial surface but comprises in addition to it the at least one other partial surface. Both the partial surface as well as the other partial surface are preferably present as a rotational surface or are level or plane. The two partial surfaces are angled against one another, and are therefore not in alignment with one another—viewed in the longitudinal section. The first welding surface can basically be composed of the partial surface and of any number of other partial surfaces. The other partial surfaces preferably lie in a radial direction on the inside of the partial surface. The partial surface as well as the at least one other partial surface can be annular, in particular have a circular ring shape. If several other partial surfaces are provided, they are preferably—again viewed in the longitudinal section—also angled against each other.

It is provided in the framework of another advantageous embodiment of the invention that the first welding surface borders on an inner circumferential surface of the first plastic molded part and that the second welding surface borders on an outer circumferential surface of the second plastic molded part, wherein the inner circumferential and the outer circumferential surface—viewed at least in sections in the circumferential direction—are arranged relative to one another with a clearance fit or a transitional fit. The inner circumferential surface of the first plastic molded part limits the receiving means of the first plastic molded part in a radially outward direction. It is preferably cylindrical, especially circularly cylindrical. The outer circumferential surface of the second molded part can also be cylindrical, or circularly cylindrical. The outer circumferential surface and the inner circumferential surface are preferably adapted to the shape of the other one, that is, they have, for example, the same shape but not necessarily the same dimensions.

However, it can also be provided that the first plastic molded part in the receiving means comprises radially inwardly projecting ribs. Preferably, each two of these ribs are arranged diametrically opposite one another as regards the longitudinal central axis of the first plastic molded part. It is furthermore preferred that the ribs are arranged uniformly distributed in the circumferential direction. The main direction of the extension of the ribs is preferably in the axial direction so that the longitudinal central axes of the ribs run parallel to the longitudinal central axis of the first plastic molded part.

Additionally or alternatively, the second plastic molded part can comprise radially outwardly projecting ribs in particular on its welding region. Here too, each two ribs can be arranged diametrically opposite one another and/or be uniformly distributed in the circumferential direction regarding the longitudinal central axis of the second plastic molded part. The main direction of the extension of the ribs is again preferably in the axial direction so that longitudinal central axes of the ribs run parallel to the longitudinal central axis of the second plastic molded part.

In sum, therefore, ribs can be present on each of the two plastic molded parts which extend radially in the direction of the particular other plastic molded part. However, it can also be provided that the ribs are arranged only on one of the two plastic molded parts whereas the particular other plastic molded part comprises the cylindrical or circularly cylindrical outer circumferential surface or inner circumferential surface. The ribs are designed in such a manner here that they rest on the particular other plastic molded part in particular with a press fit. This achieves a very precise centering of the two plastic molded parts against one another in a simple manner. Therefore, the outer circumferential surface rests in the area of the ribs on the inner circumferential surface, in particular with a press fit viewed in the circumferential direction, whereas it is at a distance from it in areas located between the ribs or rests on it only with a clearance fit or transitional fit. Inversely, this applies, of course, to the inner circumferential surface which, viewed in the circumferential direction, rests in areas on the inner circumferential surface and is at a distance from it in areas or rests with a slight surface pressure, in particular with a clearance fit or transitional fit, on the outer circumferential surface.

To this extent, the two plastic molded parts are designed in such a manner that the inner circumferential surface and the outer circumferential surface do not rest continuously on one another with a press fit in the arrangement of the second plastic molded part in the receiving means of the first plastic molded part—viewed in the circumferential direction—but rather that in any case there is a clearance fit or a transitional fit between them at least in areas or they are at a distance from one another in a radial direction. As a result of such a design of the plastic molded parts, a thermal transfer from the second plastic molded part onto the first plastic molded part via the outer circumferential surface and the inner circumferential surface should be avoided. The thermal transfer should take place to this extent preferably at least for the most part, in particular exclusively via the welding surface.

It is provided in the framework of another embodiment of the invention that a laser beam used for the laser welding receives the first rotational surface in itself, in particular centrally, or adjacently, in particular directly adjacently to the first rotational surface. This arrangement of the laser beam is preferably realized at least directly at the beginning of the laser welding, but especially preferably during the entire laser welding. The first-cited arrangement, according to which the laser beam receives the first rotational surface, can be considered as optimal because in this manner a tolerance compensation is realized regarding an arrangement on the plastic molded parts to one another. At least a part of the laser beam therefore strikes directly on the particular other plastic molded part after passing through the plastic molded part consisting of the laser-transparent material.

However, the laser beam can also be arranged adjacent to the first rotational surface, in particular directly adjacent. It is to be understood with the directly adjacent arrangement that the laser beam directly follows the first rotational surface but does not receive it in itself. Two different variants result for the adjacent arrangement. In the first one the laser beam is arranged in such a manner that it is completely present on the side of the first rotational surface facing away from the second plastic molded part. Accordingly, the laser beam does not strike or at least does not directly strike the second plastic molded part. The laser welding takes place in such an alignment of the laser beam at least partially by a heating of the plastic molded part consisting of the laser-absorbing material from which the heat caused by the laser beam is transferred to the particular other plastic molded part so that the previously described melting of the first material and/or or the second material takes place. Additionally or alternatively, a part of the laser beam can pass by refraction in the first plastic molded part and/or in the second plastic molded part into the plastic molded part consisting of the laser-absorbing material and heat and finally melt it.

In a second variant the laser beam is arranged completely on the side of the first rotational surface facing the second plastic molded part. To this extent, it can be assumed that the entire laser beam, after having passed through the plastic molded part consisting of the laser-transparent material, strikes the particular other plastic molded part and heats it. This does optimize the charging of heat into the last-cited plastic molded part; however, the laser beam does not strike or only partly strikes the already molten, first material and/or second material which is present in a mixing zone of the first material and of the second material.

Another preferred embodiment of the invention provides that the laser beam is positioned in a stationary manner as regards the first plastic molded part and/or the second plastic molded part. It was previously explained that the two plastic molded part are shifted onto one another during the laser welding. In order to be able to carry out the laser welding with the laser beam, the laser beam must be appropriately aligned. It is stationary to this end as regards at least one of the plastic molded parts. If, for example, a shifting of the first plastic molded part in the direction of the second plastic molded part is intended, the laser beam can be shifted in common with the first plastic molded part. On the other hand, if the first plastic molded part is stationary and the second plastic molded part is shifted onto the first plastic molded part, then the laser beam can also be stationary. It is preferably understood here that the laser beam is stationary relative to the particular welding surface or the particular rotational surface. In the case of a shifting onto one another of the two plastic molded parts, to this extent a stationary arrangement can also be realized regarding both plastic molded parts, in particular by an arrangement of the laser beam which is absolutely stationary.

Another embodiment of the invention provides that the laser beam is aligned parallel to the first rotational surface or is bent relative to the first rotational surface, wherein the first welding surface is located at least partially and in particular completely in the laser beam. Basically, the laser beam can be aligned as desired as long as it brings about the welding of the two plastic molded parts with one another. It preferably lies parallel to the first rotational surface, at least in the longitudinal section on one side of the longitudinal central axis. However, it can also be bent as regards the first rotational surface. In the case of the bent alignment, it is preferably provided that the laser beam intersects the first welding surface. The width of the laser beam is especially preferably selected in such a manner here that the entire first welding surface or at least its partial surface lies in the laser beam.

Additionally or alternatively, a preferred embodiment can provide that the second plastic molded part is formed in several layers, wherein the layers of the second plastic molded part consist of materials with different melting temperatures and the second welding surface is formed from at least one of the layers, in particular only a subset of the layers. The second plastic molded part consists to this extent of several layers which are successively arranged in particular in a radial direction relative to a longitudinal central axis of the first plastic molded part. A first layer is surrounded, for example, by a second layer in the circumferential direction at least in part and especially completely.

For its part, this second layer can be surrounded at least partially, especially completely by a third layer in the circumferential direction. Again, another layer or any desired number of other layers can follow on the latter. Basically, any desired number of layers can be provided, for example, exactly two layers or exactly three layers. The several layers preferably run continuously in the axial direction, in particular over the entire longitudinal extent of the second plastic molded part. However, the second plastic molded part can alternatively also be built up with several layers only on its side facing the first plastic molded part, in particular in the welding region received in the receiving means, or it can comprise a number of layers there which is different from the number present in another area.

The layers of the second plastic molded part or at least immediately adjacent layers preferably consist of materials with different melting temperatures. The melting temperatures of the materials can be selected in such a manner that only exactly one or only one part of the layers is melted during the laser welding by the laser beam. Alternatively or additionally, the material of at least one of the layers is laser-transparent and the material of at least one of the other layers is laser-absorbing. Accordingly, the welding surface is only formed by at least one of the layers, therefore, for example, only one of the layers or only a subset of the layers. The subset comprises only a part of the layers of the second plastic molded part. For example, only one of the layers consists of the second material. Alternatively, several, in particular layers adjacent to one another or at a distance from one another can be produced from the second material.

Another embodiment of the invention provides that the first plastic molded part and/or the second plastic molded part and/or the insertion part are produced from a laser-transparent or a laser-absorbing material. Depending on the intended procedure, for example, whether an outer welding or an inner welding is to be realized, basically any combinations of the material for the first plastic molded part, the second plastic molded part and the insertion can result. For example, in an outer welding the first plastic molded part preferably consists of a laser-transparent material and the second plastic molded part of a laser-absorbing material; in an inner welding this can be different. If the insertion part is provided, both plastic molded parts can consist of laser-transparent material. The insertion part then consists of laser-absorbing material. At least one of the plastic molded parts, for example, even both plastic molded parts, can, however, also then consist of laser-absorbing material. If different elements should consist of laser-absorbing material or of laser-transparent material, this does not necessarily mean that the same material is used. Rather, different laser-absorbing materials or different laser-transparent materials can of course be used.

It can be provided in the framework of another embodiment of the invention that the relative position of the first plastic molded part and of the second plastic molded part relative to one another is detected in the course of time, in particular at at least one point in time, and is evaluated for the quality assurance of the molded part assembly. The measuring time in which the relative position is detected at least once comprises, for example, a welding time which extends, for example, from a beginning of the laser welding, that is, from the generation of the laser beam to the end of the laser welding, that is, to the turning off of the laser beam. In addition, the measuring time can comprise a stop time which directly follows the laser welding or the welding time, that is, at the turning off of the laser beam. The stop time preferably extends for a certain time span during which the two plastic molded parts are shifted further toward one another or at least the shifting force is further impressed on them.

The relative position during the measuring time is detected at least once, in particular several times, but especially preferably in a continuous or periodic manner. If the relative position corresponds to a theoretical value or lies in a theoretical value range, it is assumed that the assembly of the molded part is in order. On the other hand, if the relative position deviates from the theoretical position or lies outside of the theoretical value range, a molded part assembly which was not produced in an orderly manner is recognized. The theoretical value or the theoretical value range here is naturally a function of the time at which the relative position is determined. If the relative position is determined several times in the measuring time, in particular, therefore, in the form of a course of relative position, then this course of relative position can be compared with a theoretical value course or with the theoretical value range. If it corresponds to the latter or if it is located in the latter, then a molded part assembly produced in an orderly manner is again concluded while otherwise a molded part assembly not produced in an orderly manner is recognized.

Furthermore, a production device for producing a molded part assembly is described consisting of a first plastic molded part and a second plastic molded part by laser welding, in particular for carrying out the previously described method, wherein the first plastic molded part consists at least partially of a first material and the second plastic molded part consists at least partially of a second material which can be welded to the first material, wherein it is provided that a welding region of the second plastic molded part is arranged in a stepped receiving means of the first plastic molded part or vice versa. The production device is designed to shift the first plastic molded part and the second plastic molded part onto one another in a shifting direction during the laser welding,

Reference has already been made to the advantages of such a procedure and to such a construction of the production device and to the molded part assembly. Both the method as well as the production device for carrying it out can be further developed according to the above embodiments.

The invention is explained in detail in the following using the exemplary embodiment shown in the drawings with no limitation of the invention taking place. In the drawings:

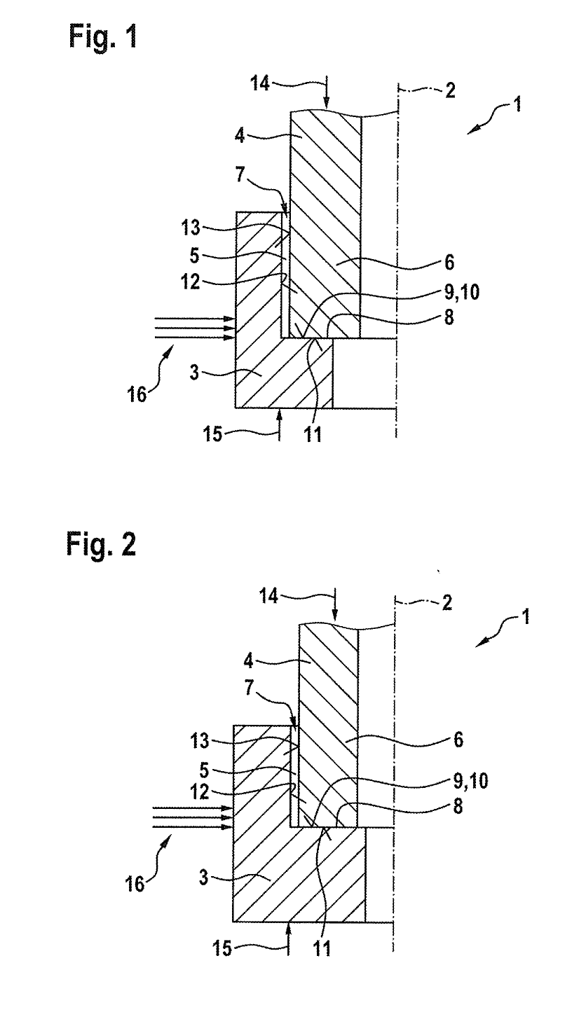

FIG. 1 shows a schematic view of a molded part assembly with a first plastic molded part and a second plastic molded part in a first embodiment,

FIG. 2 shows a schematic view of the molded part assembly in a second embodiment,

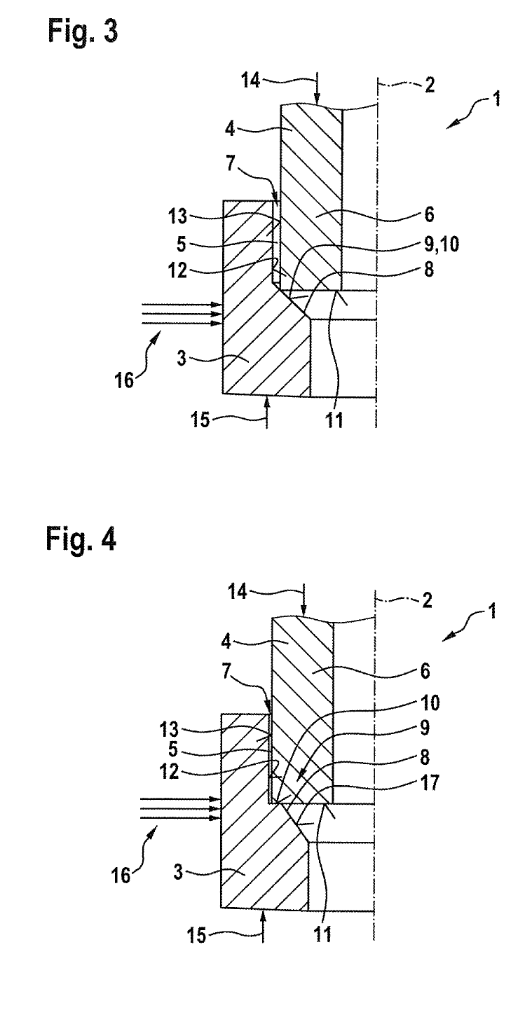

FIG. 3 shows a schematic view of the molded part assembly in a third embodiment,

FIG. 4 shows a schematic view of the molded part assembly in a fourth embodiment,

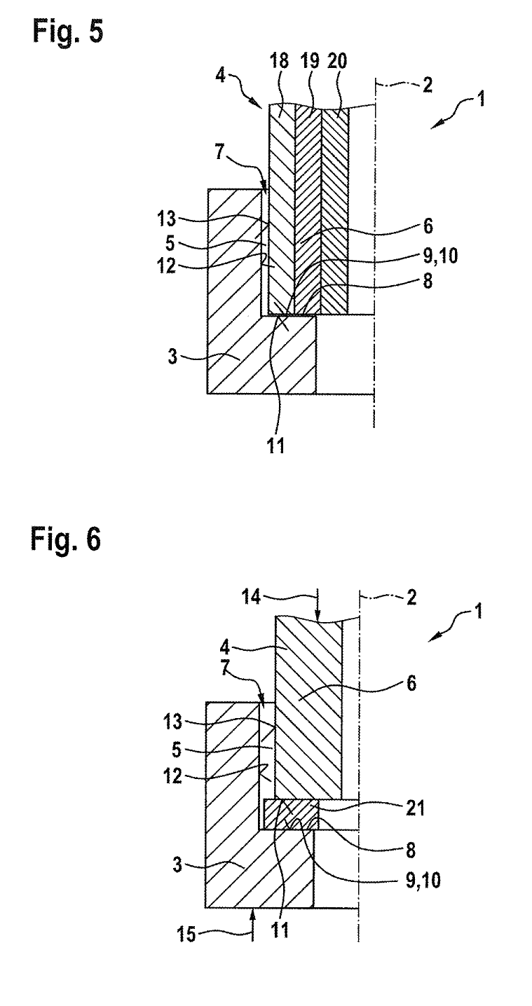

FIG. 5 shows a schematic view of the molded part assembly, wherein the second plastic molded part is constructed with several layers,

FIG. 6 shows a schematic view of the molded part assembly, wherein an insertion part is arranged between the first plastic molded part and the second plastic molded part, and

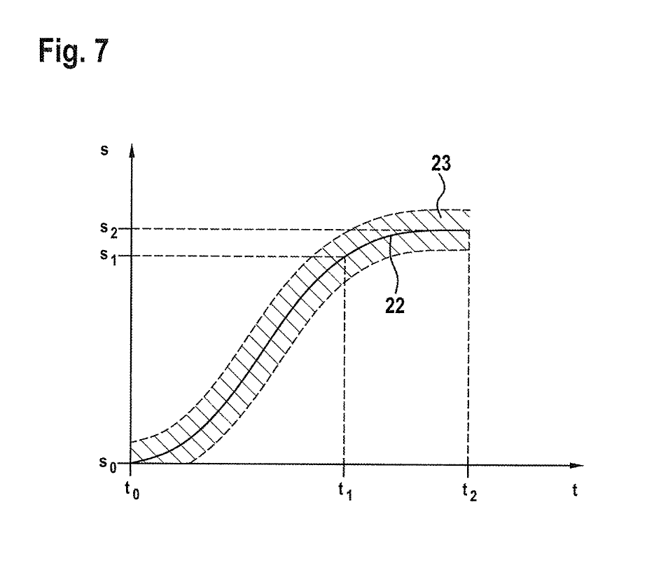

FIG. 7 shows a diagram in which a relative position of the first plastic molded part and of the second plastic molded part relative to one another is recorded in the course of time.

FIG. 1 shows a schematic view of a molded part assembly 1 in a longitudinal section relative to a longitudinal central axis 2. The molded part assembly 1 comprises a first plastic molded part 3 and a second plastic molded part 4. Both plastic molded parts 3 and 4 can be designed, for example, as fluid line elements. They are only shown here by way of example and in a schematic manner. The first plastic molded part 3 is preferably a fluid coupling and the second plastic molded part 4 is a fluid line. The plastic molded parts 3 and 4 can basically be produced in any manner, for example, by injection molding or extruding. The first plastic molded part 3 is preferably an injection-molded part and the second plastic molded part 4 an extrusion molded part. However, even other embodiments are possible.

The first plastic molded part 3 comprises a receiving means 5 for the second plastic molded part 4 and for a welding region 6 of the second plastic molded part 4. The receiving means 5 comprises a mouth opening 7 formed on the front side on the first plastic molded part 3 and is limited on the side opposite the mouth opening 7—viewed in the axial direction—by a step 8. The receiving means 5 is designed to this extent as a stepped receiving means. The step 8 brings about a change in the dimensions and of the inner cross-sectional surface of the receiving means 5. In addition, in the exemplary embodiment shown here it preferably forms an end stop for the second plastic molded part 4. The plastic molded parts 3 and 4 are correspondingly designed so that the second plastic molded part 4 can be introduced into the receiving means 5 up to the attaining of the step 8 and subsequently rests on the latter or is supported on it.

A first welding surface 9 is formed in the receiving means and rests in the rotational surface at least by a partial surface 10. The first welding surface 9 or the partial surface 10 faces the second plastic molded part 4. The first welding surface 9, in particular the partial surface 10, is preferably formed by the step 8. The first welding surface 9 and its partial surface 10 is preferably annular, in particular with a circular ring shape. A second welding surface 11 is formed on the second plastic molded part 4 on the front side. This welding surface is located in the second rotational surface and faces the first plastic molded part 3. The second welding surface 11 rests on the first welding surface 9, in particular on the partial surface 10 of the first welding surface 9. In the exemplary embodiment shown here, the front side of the second plastic molded part 4 is greater in a radial direction than the step 8 so that the second plastic molded part 4, viewed in a cross section, projects inward over the step 8.

An inner circumferential surface 12 of the first plastic molded part 3 follows the first welding surface 9 and which limits the receiving means 5 in an outward radial direction. The inner circumferential surface 12 extends in an axial direction preferably from the first welding surface 9 to the mouth opening 7 through which the second plastic molded part 4 can be introduced into the receiving means 5. The inner circumferential surface 12 is preferably cylindrical, especially circularly cylindrical. For example, it encloses a certain angle, in particular 90°, with the first welding surface 9 and the partial surface 10. On the other hand, the second welding surface 11 borders on an outer circumferential surface 13 of the second plastic molded part 4. The outer circumferential surface 13 can also be cylindrical, especially circularly cylindrical, and encloses an angle, in particular an angle of 90° with the second welding surface 11, preferably—viewed in the circumferential direction, at least in areas or continuously.

The plastic molded parts 3 and 4 are constructed in such a manner that the inner circumferential surface 12 and the outer circumferential surface 13 are in any case not or at best—viewed in the circumferential direction—arranged in areas with a press fit to one another but rather only with a clearance fit or a transitional fit. This is indicated in the representation by the distance between them. It is preferably provided that the outer circumferential surface 13 is also formed by ribs which are not shown here and which are formed at a distance from each other in a circumferential direction on the plastic molded part 4 and project in a radial direction in the direction of the plastic molded part 3 and the inner circumferential surface 12. For example, the outer circumferential surface 13—viewed in the circumferential direction—rests only in the area of the ribs on the inner circumferential direction 12 and in areas located between the ribs with a lesser surface pressure or none at all. In the latter case the outer circumferential surface is arranged in the areas between the ribs, therefore at a distance from the inner circumferential surface. The ribs have their longitudinal central axis in an axial direction, therefore preferably parallel to the longitudinal central axis 2. They serve for a simple and reliable centering of the plastic molded part 4 as regards the plastic molded part 3 and can accordingly also be designated as centering ribs.

In the first embodiment shown here the first rotational surface and the second rotational surface are arranged parallel to one another and both stand vertically on the longitudinal central axis 2 and the shifting direction of the plastic molded part 3 and 4 indicated by the arrows 14 and 15 in which they are shifted onto one another during a laser welding process. The shifting direction is preferably parallel to the longitudinal central axis 2 or coincides with it. The two rotational surfaces are located in the embodiment shown here in the same plane or at least in two planes arranged parallel to one another.

In order to produce the molded part assembly 1, the plastic molded parts 3 and 4 are connected to one another by laser welding. For this, the welding region 6 of the second plastic molded part 4 is arranged in the receiving means 5 of the first plastic molded part 3. A laser beam 16 is generated already before the welding surfaces 9 and 11 make contact with one another or after such a contacting, with which the laser welding is performed. The first plastic molded part consists at least partially of a first material which is laser-transparent whereas the second plastic molded part 4 consists at least partially of a second material which is laser-absorbing. In addition, the second material can be welded to the first material and can, therefore, be firmly bonded to it by the laser welding. The first material and the second material can basically be different or consist of the same base material which is made laser-transparent and/or laser-absorbent by additives.

During the laser welding the two plastic molded parts 3 and 4 are shifted onto one another with welding surfaces 9 and 11 located on one another. This is made possible by the melting of the first plastic molded part 3 and/or of the second plastic molded part 4 in areas by the laser beam 16. For shifting the plastic molded parts 3 and 4 onto one another, a shifting force is impressed on them. For example, the shifting force is impressed in the direction of the arrow 14 onto the second plastic molded part 4 and/or in the direction of the arrow 15 on the first plastic molded part 3.

FIG. 2 shows a schematic view of a second embodiment of the molded part assembly 1. It is basically similar to the first embodiment, so that in the following only the differences will be discussed and otherwise reference is made to the previous explanations. The differences are that the front surface of the second plastic molded part 4 is smaller in the radial direction than the step 8, so that, viewed in cross section—the front surface of the second plastic molded part 4 rests completely on the step 8 during the laser welding.

FIG. 3 shows a third embodiment of the molded part assembly 1. Again, only the differences from the first embodiment will be discussed and otherwise reference is made to the previous explanations. The differences are that the first rotational surface, which defines the first welding surface 9, is bent relative to the second rotational surface defining the second welding surface 11. In addition, the first rotational surface is obliquely aligned relative to the longitudinal central axis 2 and to the shifting direction and therefore intersects them at an angle different from 90°. The first welding surface 9 is present in the exemplary embodiment shown here as a sectional surface of a cone envelope. In contrast thereto, the first rotational surface is preferably aligned vertically to the longitudinal central axis 2. However, it can also be arranged obliquely to the latter, but is preferably bent relative to the first rotational surface, in particular inclined—viewed in longitudinal section—in the other direction.

FIG. 4 shows a fourth embodiment of the molded part assembly 1. The differences from the first embodiment, the description of which is basically referred to, are that the first welding surface 9 comprises in addition to the partial surface 10 another partial surface 17. This latter one is bent relative to the partial surface 10 and preferably directly follows it. The partial surface 17 is also plane or level just as the partial surface 10. The welding surface 9 is located in the exemplary embodiment shown vertically to the longitudinal central axis 2 whereas the partial surface 17 is bent and to this extent is shaped like a sectional surface of a cone envelope.

FIG. 5 shows a variant of the molded part assembly 1 in which the second plastic molded part 4 is multi-layered and to this extent has multiple layers, here, for example, layers 18, 19 and 20. Otherwise, reference is made to the previous explanations. In particular, the welded surfaces 9 and 11 can be shaped according to one of the embodiments according to the previous explanations. For example, the layers 18, 19 and 20 consist of different materials. In particular, it is provided here that the layer 18 arranged directly adjacent to the inner circumferential surface 12 limiting the receiving means 5 in an outwardly radial direction consists of a material that can be welded to the material of the first plastic molded part 3. In contrast thereto, the layer 19 be constructed as a filler layer and to this extent can consist of a material, in particular an economical material, that cannot be welded to the first material of the first plastic molded part 3. On the other hand, the layer 20 can be constructed in such a manner that it has a sufficient resistance to a fluid to be transported in the second plastic molded part 4. For example, the layer 18 as well as the first plastic molded part 3 consist of PA6.12 or PA12. The layer 19 can consist of PA6, in contrast to which the layer 20 is produced, for example, from PPA or fluoropolymer.

It can be additionally or alternatively provided that the first plastic molded part 3 and the layer 18 consist of a laser-absorbing material whereas a laser-transparent material is provided for the layers 19 and 20. In this instance, for example, an inner welding can be performed in which the laser beam 16 passes outwardly through the layers 19 and 20 in a radial direction and is absorbed by the layer 18 and the first plastic molded part 3 so that the layer 18 is welded to the first plastic molded part 3. In this instance the layer 18 consists of the second material of the second plastic molded part 4, which can be welded to the first material of the first plastic molded part 3. However, any other material combinations can also be realized for the layers 18, 19 and 20.

FIG. 6 shows a schematic view of the molded part assembly 1, wherein an inserted part 21 is arranged between the first plastic molded part 3 and the second plastic molded part 4. The inserted part 21 preferably lies, viewed in an axial direction, on the one hand on the first plastic molded part 3, in particular on the first welding surface 9, and on the other hand on the second plastic molded part 4, in particular on the second welding surface 11. In the radial direction it can rest on the inner circumferential surface 12 or be arranged at a distance from it. The insertion part 21 preferably consists of laser-absorbing material. The first plastic molded part 3 and the second plastic molded part 4 can both consist of laser-transparent material. However, one of the plastic molded parts 3 and 4 can also consist of a laser-absorbing material, for example, the first plastic molded part in an inner welding and the second plastic molded part in an outer welding. The insertion part 21 is melted under the influence of the laser beam 16 so that it is made possible to shift the plastic molded parts 3 and 4 onto one another.

FIG. 7 shows a diagram in which a relative position s of the two plastic molded parts 3 and 4 is recorded over the time t. After a time t≥t₀, the laser welding is carried out and the laser beam 16 is therefore generated. Likewise, after the time t≥t₀, the shifting of the plastic molded part 3 and 4 onto one another and/or their loading with the shifting force begins. The laser beam 16 stays actuated for a total welding time which ends at time t=t₁. The welding time is therefore t₁≤t≤t₁. A holding time for t₁≤t≤t₂ directly follows the welding time. The holding time ends at the time t=t₂.

During the time consisting of the welding time and the holding time the relative position s is retained for the time t. The relative positions S=S₀, S₁ and S₂ are indicated purely as examples here for the times t=t₀, t₁ and t₂. However, only one relative position at a certain time or a course of the relative position s can also be detected. Such a relative position course is indicated by the course 22 which runs through the previously explained relative positions. If this course 22 follows a theoretical value course or lies in a theoretical value range 23, it can be assumed that the produced molded part assembly 1 is in order. Otherwise, a produced molded part assembly 1 which is not in order as assumed.

An economical laser welding of the two plastic molded parts 3 and 4 with a reliable process is possible with the aid of the previously described molded part assembly 1 and the explained procedure. The production of the molded part assemblies 1 is on the one hand possible with low waste and on the other hand the waste can be reliably recognized.

1. A method for producing a molded part assembly from a first plastic molded part and from a second plastic molded part by laser welding, wherein the first plastic molded part consists at least partially of a first material and the second plastic molded part consists at least partially of a second material which can be welded to the first material, wherein a welding region of the second plastic molded part is arranged in a stepped receiving means of the first plastic molded part or vice versa, wherein the plastic molded parts are present as a fluid line element, that a first welding surface of the first plastic molded part which welding surface is located at least with a partial surface in the first rotational surface and faces the second plastic molded part is formed in the receiving means, and a front-side, second welding surface located in the second rotational surface and facing the first plastic molded part is formed on the second plastic molded part, and that the first plastic molded part and the second plastic molded part are shifted onto one another in the shifting direction during the laser welding, wherein the first welding surface and the second welding surface contact one another or are supported on one another by an insertion part, and wherein a laser beam used for the laser welding is directed inward or outward in a radial direction.

2. The method according to claim 1, wherein the first welding surface and the second welding surface are constructed in such a manner that the first rotational surface and the second rotational surface—viewed in a longitudinal section—are angled parallel to one another or against and/or that the first rotational surface and/or the second rotational surface stand vertically on the shifting direction.

3. The method according to claim 1, wherein the first welding surface is constructed with at least one other partial surface which is angled opposite the partial surface.

4. The method according to claim 1, wherein the first welding surface is adjacent to an inner circumferential surface of the first plastic molded part and that the second welded surface is adjacent to an outer circumferential surface of the second plastic molded part, wherein the inner circumferential surface and the outer circumferential surface—viewed at least in sections in the circumferential direction—are arranged relative to one another with a clearance fit or a transitional fit.

5. The method according to claim 1, wherein a laser beam used for the laser welding receives the first rotational surface in itself and is arranged in particular centrally or adjacently, in particular directly adjacently to the first rotational surface.

6. The method according to claim 5, wherein the laser beam is positioned in a stationary manner relative to the first plastic molded part and/or to the second plastic molded part.

7. The method according to one of the previous claims claim 1, wherein the laser beam is aligned parallel to the first rotational surface or is angled relative to the first rotational surface, wherein the first welding surface lies at least partially, in particular entirely in the laser beam.

8. The method according to claim 1, wherein the second plastic molded part is constructed with several layers, wherein the layers of the second plastic molded part consist of materials with different melting temperatures and the second welding surface is formed by at least one of the layers, in particular only by a subset of the layers.

9. The method according to claim 1, wherein the first plastic molded part and/or the second plastic molded part and/or the insertion part are produced from a laser-transparent material or from a laser-absorbing material.

10. The method according to claim 1, wherein the relative position of the first plastic molded part and of the second plastic molded part to one another is determined over time, in particular and at least one point in time and is evaluated for ensuring the quality of the molded part assembly.
